(19) United States
(12) Patent Application Publication
(10) Pub. No.: US 2025/0297905 A1
(43) Pub. Date: Sep. 25, 2025

(54) Device and Method for Determining Horizontal Displacement of Vertical Reference Cable

(71) Applicant: Citpo Technologies Co., Ltd., Taipei (TW)

(72) Inventors: Cindy Jheng, Taipei (TW); Chun-Yi Liao, Taipei (TW)

(21) Appl. No.: 19/007,523

(22) Filed: Jan. 1, 2025

(30) Foreign Application Priority Data
Mar. 19, 2024 (TW) 113110186

(51) Int. Cl. G01L 1/24

(52) U.S. Cl. CPC G01L 1/246

(57) ABSTRACT

A device and a method for determining the horizontal displacement of a vertical reference cable are provided. The device is installed within a structure with a vertical cavity, and includes a first rectangular guide rail, a second rectangular guide rail, and a slider. A shorter side of the first rectangular guide rail is coupled to an inner wall of the vertical cavity through a first spring and a first fiber Bragg grating. A shorter side of the second rectangular guide rail is coupled to the inner wall of the vertical cavity through a second spring and a second fiber Bragg grating. The first rectangular guide rail and the second rectangular guide rail are perpendicularly intersected to form a vertical intersecting space. The slider is placed within this vertical intersecting space and is in contact with both the first rectangular guide rail and the second rectangular guide rail.

### CROSS-REFERENCE TO RELATED APPLICATION AND CLAIM OF PRIORITY

The application claims the benefit of Taiwan Patent Application No. 113110186, filed on Mar. 19, 2024, at the Taiwan Intellectual Property Office, the disclosures of which are incorporated herein in their entirety by reference.

### FIELD OF THE DISCLOSURE

The present disclosure relates to a device and a method for determining the horizontal displacement of a vertical reference cable and, more particularly, to a device and a method using intersecting rectangular guide rails to determine the horizontal displacement of the vertical reference cable relative to a surrounding structure based on the deflection measurement.

### BACKGROUND OF THE DISCLOSURE

A plumb line device is commonly used to monitor the displacement of tall structures under different force conditions relative to a reference vertical line. A plumb line device having a fixed end of this reference vertical line located at the top of the structure is called a normal plumb line device 10, as shown in FIG. 1. A plumb line device having a fixed end of this reference vertical line located at the bottom of the structure is called an inverted plumb line device 20, as shown in FIG. 2. FIG. 1 and FIG. 2 respectively show schematic diagrams of the normal plumb line device 10 installed in a concrete dam 11 and the inverted plumb line device 20 installed in the foundation ground 21. They can measure the horizontal displacement of the concrete dam 11 relative to the foundation ground 21 and the horizontal displacement of the foundation ground 21 relative to the immovable bedrock 22 in the deep layers when the water level of the reservoir 12 changes.

In FIG. 1 and FIG. 2, the vertical reference cables 101 and 201 are made of steel cables with diameters of several millimeters (mm). The vertical reference cable 101 of the normal plumb line device 10 has a fixed end 103 at the top, and a weight 102 of about 30 kg is used to straighten the vertical reference cable 101 from its bottom end. The vertical reference cable 201 of the inverted plumb line device 20 has a fixed end 203 at the bottom, and a buoyancy device 202 is used to apply a tension of about 30 kg from the top end of the vertical reference cable 201 to straighten the vertical reference cable 201 and provide a damping function. The weight 102 and buoyancy device 202 are immersed in an oil tank 13 that provides the damping function.

In practice, during the construction of the concrete dam 11, a hole 14 is reserved for installing the normal plumb line device 10, and the fixed end 203 of the vertical reference cable 201 of the inverted plumb line device 20 is fixed to the bottom of the hole 24 by grouting. The weight 102 at the tension end of the normal plumb line device 10 is installed in the hole 14. In the normal plumb line device 10, multiple displacement measurement points are available at different heights within the concrete dam 11 to determine the distribution of the horizontal displacement of the concrete dam 11. In the concrete dam 11, especially in areas below the water level, the humidity is usually very high. Conventional techniques often use laser light to measure the relative displacement between the vertical reference cable at the displacement measurement point and the surrounding dam structure. However, photo-electronic equipment is easily damaged in high humidity environments, and its maintenance costs are often extremely high.

The optic fibers described herein have an elongated cylindrical structure that has pure silicon dioxide as its core. Generally, a single-mode optic fiber has a circular cross section with an interior diameter of 125 μm. The core is coated with acrylics with an overall diameter of 250 μm. A regular optic fiber can withstand a tensile strain up to 10,000 μεs. A brief description of the principles of FBG sensing techniques commonly used today is provided as follows.

FIG. 3 illustrates the principles of light reflection from an optic fiber Bragg grating (FBG). As shown in FIG. 3, the manufacturing of an FBG involves exposing a 1-20 mm long optic fiber 300, which includes an optic fiber core 301 coated by an acrylic layer 302, under high energy ultraviolet light that causes the refraction index of the exposed section of the optic fiber 300 to be permanently and periodically varied. The exposed section of the optic fiber 300 with refraction index variation at a period A is called an FBG 303. When continuous and wide-band light 304 enters the optic fiber core 301 that contains the FBG 303, only light 305 with a special wavelength that meets the Bragg condition is reflected and the rest of the light 306 passes through the FBG 303. When the FBG 303 is subject to an external force or temperature variations to generate a strain (ε_{B}), the period A of the grating changes, causing the wavelength of the reflected light 305 from the FBG 303 to be shifted. The relation among the original wavelength λ_{B} of the reflected light 305, its variation Δλ_{B} and the strain ε_{B} can be defined by the following equation:

$${Δλ}_{B} = 0.74 {λ}_{B} {ε}_{B} or {ε}_{B} = \frac{Δ {λ}_{B}}{( 0.74 {λ}_{B} )} . \qquad ( 1 )$$

The wavelength λ_{B} of the FBG 303 that is commonly used is in a range from 1525 to 1575 nm, and the variation Δλ_{B} that can be identified by a typical FBG interrogator is 1 pm. According to Equation (1), Δλ_{B} of 1 pm corresponds to a strain ε_{B} that is slightly less than 10⁻⁶, making the FBG 303 a stable and sensitive strain gauge.

Conventional photo-electronic technologies are prone to short-circuiting when deployed in humid environments for extended periods. Prolonged use of electronic signals also results in signal drift, leading to insufficient stability and high maintenance costs. Fiber Bragg grating and optical fibers are non-conductive, and their stabilities are unaffected by humidity or lightning. Fiber Bragg grating measures strain using light wavelengths, which are not influenced by light source intensity, and thus ensuring long-term stability. This makes them highly suitable as sensing units for long-term use in humid environments.

Therefore, the inventor, in view of the shortcomings of conventional techniques, has come up with the idea of the disclosure, and finally developed a device and a method for determining the horizontal displacement of a vertical reference cable.

### SUMMARY OF THE DISCLOSURE

The primary objective of the present disclosure is to provide a device and a method for determining the horizontal displacement of a vertical reference cable, which uses fiber Bragg gratings as the sensing units combined with a simple mechanical structure, to obtain a horizontal displacement sensing (HDS) that is low cost, robust, durable and suitable for long-term use in harsh conditions, and is unaffected by humid environments.

To achieve the above objective, in one aspect, the present disclosure provides a device for determining a horizontal displacement of a vertical reference cable. The device is installed in a structure with a vertical cavity and includes a first rectangular guide rail, a second rectangular guide rail, and a slider. A short side of the first rectangular guide rail is coupled to an inner wall of the vertical cavity via a first leaf spring and a first fiber Bragg grating. A short side of the second rectangular guide rail is coupled to the inner wall of the vertical cavity via a second leaf spring and a second fiber Bragg grating. The first rectangular guide rail and the second rectangular guide rail intersect perpendicularly to form a perpendicular cross space. The slider is positioned in the perpendicular cross space and in contact with the first rectangular guide rail and the second rectangular guide rail. The slider has a central through-hole allowing the vertical reference cable to pass through and the horizontal displacement of the vertical reference cable is calculated based on strains of the first fiber Bragg grating and the second fiber Bragg grating when the structure deforms.

To achieve the above objective, in another aspect, the present disclosure provides a method for determining a horizontal displacement of a vertical reference cable. The method is adapted for use in a structure with a vertical cavity and includes the following steps: To begin with, a first rectangular guide rail and a second rectangular guide rail are provided. A short side of the first rectangular guide rail is coupled to an inner wall of the vertical cavity via a first leaf spring and a first fiber Bragg grating. A short side of the second rectangular guide rail is coupled to the inner wall of the vertical cavity via a second leaf spring and a second fiber Bragg grating. The first rectangular guide rail and the second rectangular guide rail intersect perpendicularly to form a perpendicular cross space. Then, a slider in the perpendicular cross space is positioned to contact the first rectangular guide rail and the second rectangular guide rail. The slider has a central through-hole allowing the vertical reference cable to pass through and the horizontal displacement of the vertical reference cable is calculated based on strains of the first fiber Bragg grating and the second fiber Bragg grating when the structure deforms.

In summary, the device and method for determining a horizontal displacement of a vertical reference cable in this disclosure use fiber Bragg gratings as the sensing units combined with a simple mechanical device. The fiber Bragg gratings have the advantages such as data stability, durability and resistance to humid environments, making the device and method for determining a horizontal displacement of a vertical reference cable highly suitable for long-term use under harsh conditions.

### BRIEF DESCRIPTION OF THE DRAWINGS

Other objectives, advantages and efficacies of the present invention will be described in detail below taken from the preferred embodiments with reference to the accompanying drawings.

FIG. 1 is a schematic diagram showing the installation and use of a conventional normal plumb line device within a concrete dam.

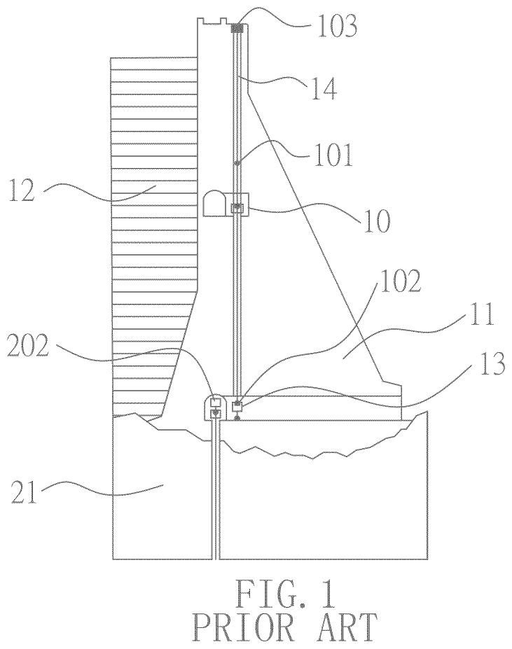

FIG. 2 is a schematic diagram showing the installation and use of a conventional inverted plumb line device within a concrete dam.

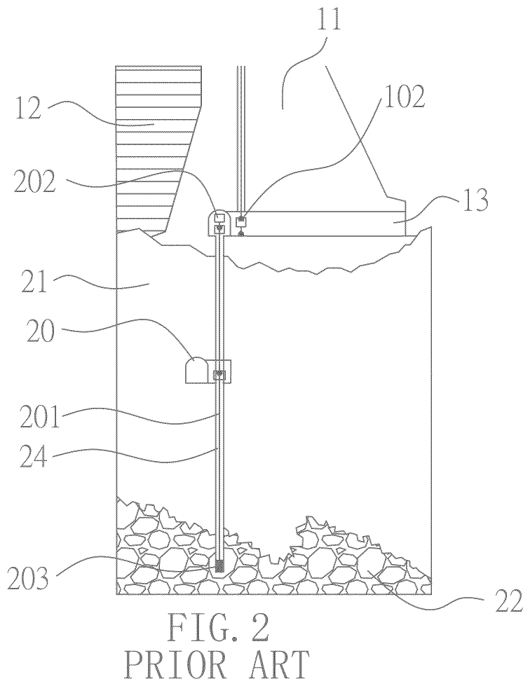

FIG. 3 is a schematic diagram showing the principle of light reflection from an FBG.

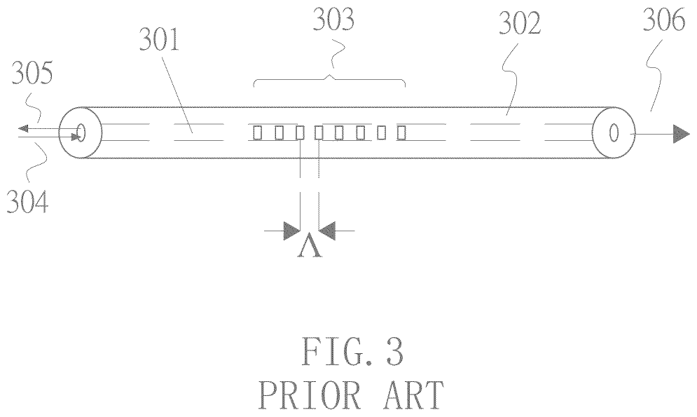

FIG. 4 is a top view schematic diagram showing a device for determining a horizontal displacement of a vertical reference cable according to one embodiment of the present disclosure.

FIG. 5 is a side view schematic diagram showing a device for determining a horizontal displacement of a vertical reference cable according to one embodiment of the present disclosure.

FIG. 6 is a schematic diagram showing the conversion of deflection angles of rectangular guide rails into a horizontal displacement in a device for determining the horizontal displacement of a vertical reference cable according to the present disclosure.

FIG. 7 is a flow chart showing a method for determining a horizontal displacement of a vertical reference cable according to one embodiment of the present disclosure.

### DETAILED DESCRIPTION OF THE PREFERRED EMBODIMENTS

Please refer to all figures of the present disclosure when reading the following detailed description, wherein all figures of the present disclosure demonstrate different embodiments of the present disclosure by showing examples, and help the skilled person in the art to understand how to implement the present disclosure. The present examples provide sufficient embodiments to demonstrate the spirit of the present disclosure, each embodiment does not conflict with the others, and new embodiments can be implemented through an arbitrary combination thereof, i.e., the present disclosure is not restricted to the embodiments disclosed in the present specification. Unless there are other restrictions defined in the specific example, the following definitions apply to the terms used throughout the specification.

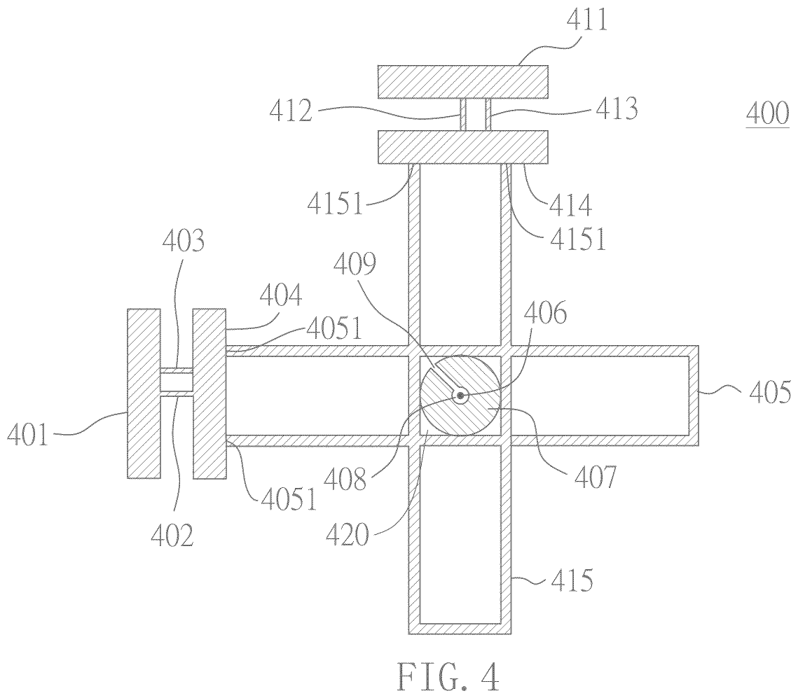

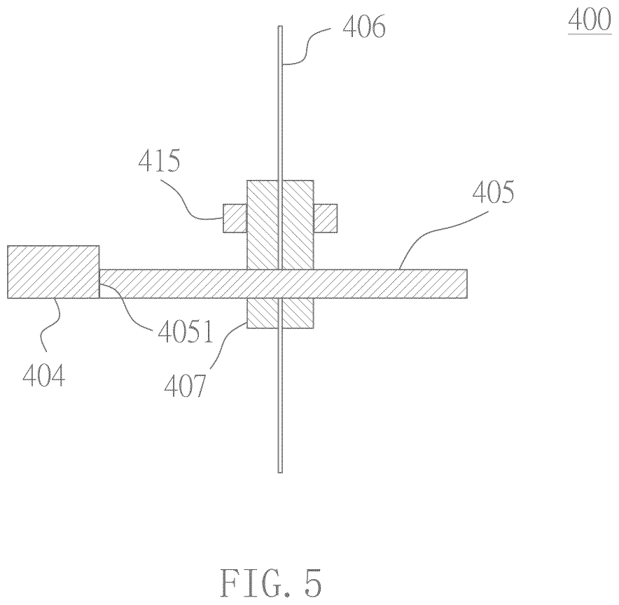

Referring to FIG. 4 and FIG. 5, which are top view and side view schematic diagrams of a device for determining a horizontal displacement of a vertical reference cable according to one embodiment of the present disclosure. The device 400 for determining a horizontal displacement of a vertical reference cable can be installed at a certain height within a structure (not shown) that has a vertical cavity. If the top of the vertical reference cable is fixed to the structure, the device 400 is called a normal plumb line device. If the fixed end of the vertical reference cable is at the bottom of the structure, the device 400 is called an inverted plumb line device. Generally, the vertical reference cable can be made of steel cables with a diameter of several millimeters, but the scope of this disclosure is not limited to this. In a normal plumb line device, a weight of about 30 kg is used to straighten the vertical reference cable from its bottom end. In an inverted plumb line device, buoyancy is used to apply a tension of about 30 kg to straighten the vertical reference cable from its top end. The weight or buoyancy device is immersed in an oil tank to provide a damping function. The cavity required for installing a normal plumb line device is reserved during the construction of the structure. The bottom of an inverted plumb line device is fixed to the bottom of a drilled hole using grouting. The tension end of an inverted plumb line device is installed in the cavity reserved during the construction of the structure. Multiple displacement measurement points can be positioned at different elevations within the structure using a normal plumb line device to determine the distribution of horizontal displacements of the structure.

In this disclosure, the device 400 mainly includes a first mounting base 401, a second mounting base 411, a first leaf spring 402, a second leaf spring 412, a first fiber Bragg grating 403, a second fiber Bragg grating 413, a first rectangular guide rail fixing unit 404, a second rectangular guide rail fixing unit 414, a first rectangular guide rail 405, a second rectangular guide rail 415, and a slider 407. The first mounting base 401 and the second mounting base 411 are respectively fixed in a vertical cavity (not shown). The first rectangular guide rail fixing unit 404 is connected to the first mounting base 401 through the first leaf spring 402 and the first fiber Bragg grating 403. Similarly, the second rectangular guide rail fixing unit 414 is connected to the second mounting base 411 through the second leaf spring 412 and the second fiber Bragg grating 413. In one embodiment, the extension directions of the first mounting base 401 and the second mounting base 411 are vertical, making the extension directions of the first rectangular guide rail fixing unit 404 and the second rectangular guide rail fixing unit 414 also vertical.

In FIG. 4 and FIG. 5, a short side 4051 of the first rectangular guide rail 405 is fixed to the first rectangular guide rail fixing unit 404, and a short side 4151 of the second rectangular guide rail 415 is fixed to the second rectangular guide rail fixing unit 414. In one embodiment, the first rectangular guide rail 405 and the second rectangular guide rail 415 intersect perpendicularly to form a perpendicular cross space 420, allowing the vertical reference cable 406 to pass therethrough. In one embodiment, the first leaf spring 402 aligns with the central axis (not shown) of the first rectangular guide rail 405, and the second leaf spring 412 aligns with the central axis (not shown) of the second rectangular guide rail 415. In this way, when a horizontal displacement of the vertical reference cable 406 relative to the surrounding structure occurs, the first rectangular guide rail 405 along the x-direction and the second rectangular guide rail 415 along the y-direction will respectively deflect by angles θₓ and θ_{y} relative to their bases. Moreover, the deflection angles θₓ and θ_{y} can also be represented by the strains of the first fiber Bragg grating 403 and the second fiber Bragg grating 413.

In FIG. 4 and FIG. 5, the slider 407 is positioned in the perpendicular cross space 420, and has a central through-hole 408 and a groove 409 recessed into the central through-hole 408. The width of the groove 409 and the diameter of the central through-hole 408 are approximately equal to the diameter of the vertical reference cable 406, allowing the vertical reference cable 406 to be squeezed into the central through-hole 408. In one embodiment, the slider 407 is a cylinder made of polytetrafluoroethylene (PTFE), commonly known as Teflon. In one embodiment, the first rectangular guide rail 405 and second rectangular guide rail 415 that are perpendicular to each other respectively contact the slider 407 with a tiny pressure. In one embodiment, the slider 407 is vertically adjusted to a height, such that the slider 407 is simultaneously surrounded by the first rectangular guide rail 405 and the second rectangular guide rail 415 and contacts them with a tiny pressure. In one embodiment, the groove 409 of the slider 407 is kept away from contacting the first rectangular guide rail 405 and the second rectangular guide rail 415. In one embodiment, when the structure deforms, the horizontal displacement of the vertical reference cable 406 is calculated based on the strains of the first fiber Bragg grating 403 and the second fiber Bragg grating 413.

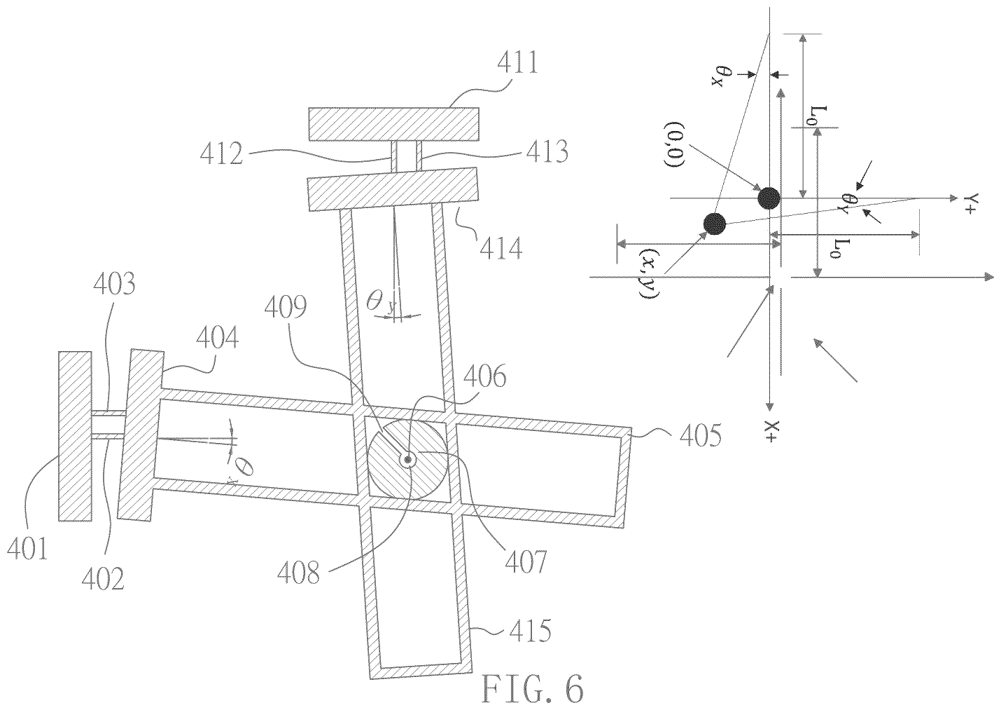

As shown in FIG. 6, which is a schematic diagram showing the conversion of deflection angles of rectangular guide rails into a horizontal displacement in a device for determining the horizontal displacement of a vertical reference cable according to the present disclosure. A coordinate system is set up with the origin (0,0) corresponding to the center of the vertical reference cable 406. The distance from the origin (0,0) to the first mounting base 401 perpendicular to the x-direction is L₀, and the distance from the origin (0,0) to the second mounting base 411 perpendicular to the y-direction is also L₀. When the slider 407 undergoes a horizontal displacement with the vertical reference cable 406, the center coordinate of the vertical reference cable 406 shifts to a position (x,y), and the first fiber Bragg grating 403 and the second fiber Bragg grating 413 respectively sense the deflection angles θₓ and θ_{y} of the first rectangular guide rail 405 and the second rectangular guide rail 415 to obtain the following relationships:

$$x = ( {L}_{0} - y ) tan {θ}_{y} \qquad ( 2 )$$

$$y = ( {L}_{0} + x ) tan {θ}_{x} . \qquad ( 3 )$$

By setting θₓ and θ_{y} as positive in the counterclockwise direction, x and y can be calculated as follows:

$$x = \frac{{L}_{0} tan {θ}_{y} ( 1 - tan {θ}_{x} )}{1 + tan {θ}_{x} tan {θ}_{y}} \qquad ( 4 )$$

$$y = \frac{{L}_{0} tan {θ}_{x} ( 1 + tan {θ}_{y} )}{1 + tan {θ}_{x} tan {θ}_{y}} . \qquad ( 5 )$$

Under normal use conditions, the displacement in the x and y directions is limited, so θₓ and θ_{y} will be much less than 90 degrees, preventing tan θₓ or tan θ_{y} from approaching infinity.

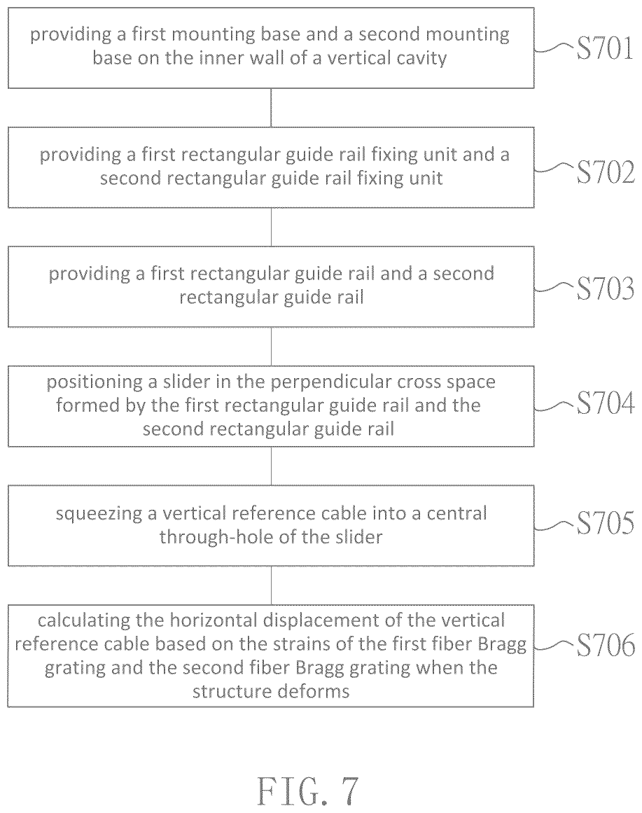

Therefore, by referring to the device 400 for determining a horizontal displacement of a vertical reference cable as shown in FIG. 4 and FIG. 5, and FIG. 7, the present disclosure provides a method for determining a horizontal displacement of a vertical reference cable, which includes the following steps. First, in step S701, a first mounting base 401 and a second mounting base 411 are provided on the inner wall of a vertical cavity (not shown).

Next, in step S702, a first rectangular guide rail fixing unit 404 and a second rectangular guide rail fixing unit 414 are provided. The first rectangular guide rail fixing unit 404 is coupled to the first mounting base 401 through a first leaf spring 402 and a first fiber Bragg grating 403. The second rectangular guide rail fixing unit 414 is coupled to the second mounting base 411 through a second leaf spring 412 and a second fiber Bragg grating 413. In one embodiment, the extension directions of the first mounting base 401 and the second mounting base 411 are vertical, making the extension directions of the first rectangular guide rail fixing unit 404 and the second rectangular guide rail fixing unit 414 also vertical.

Next, in step S703, a first rectangular guide rail 405 and a second rectangular guide rail 415 are provided. The first rectangular guide rail 405 is coupled to the first leaf spring 402 and the first fiber Bragg grating 403 via the first rectangular guide rail fixing unit 404. The second rectangular guide rail 415 is coupled to the second leaf spring 412 and the second fiber Bragg grating 413 via the second rectangular guide rail fixing unit 414. In one embodiment, the first rectangular guide rail 405 and the second rectangular guide rail 415 intersect perpendicularly to form a perpendicular cross space 420, allowing the vertical reference cable 406 to pass therethrough. In one embodiment, the first leaf spring 402 aligns with the central axis (not shown) of the first rectangular guide rail 405, and the second leaf spring 412 aligns with the central axis (not shown) of the second rectangular guide rail 415. In this way, when a horizontal displacement of the vertical reference cable 406 relative to the surrounding structure occurs, the first rectangular guide rail 405 along the x-direction and the second rectangular guide rail 415 along the y-direction will respectively deflect by angles 0, and 0,-relative to their bases. Moreover, the deflection angles 0, and 0, can also be represented by the strains of the first fiber Bragg grating 403 and the second fiber Bragg grating 413.

However, it should be noted that the above embodiment is merely an exemplary example. In other embodiments, the first leaf spring 402 and the first fiber Bragg grating 403, and the second leaf spring 412 and the second fiber Bragg grating 413 can be directly fixed to the inner wall of the vertical cavity (not shown) without the first mounting base 401 and the second mounting base 411. Additionally, in other embodiments, the short sides 4051, 4151 of the first rectangular guide rail 405 and the second rectangular guide rail 415 can be directly coupled to the first leaf spring 402 and the first fiber Bragg grating 403, and the second leaf spring 412 and the second fiber Bragg grating 413 without the first rectangular guide rail fixing unit 404 and the second rectangular guide rail fixing unit 414.

Next, in step S704, a slider 407 is positioned in the perpendicular cross space 420 formed by the first rectangular guide rail 405 and the second rectangular guide rail 415. In one embodiment, the slider 407 has a central through-hole 408 and a groove 409 recessed into the central through-hole 408. The width of the groove 409 and the diameter of the central through-hole 408 are approximately equal to the diameter of the vertical reference cable 406, allowing the vertical reference cable 406 to be squeezed into the central through-hole 408, as described in step S705. In one embodiment, the slider 407 is a cylinder made of polytetrafluoroethylene (PTFE), commonly known as Teflon. In one embodiment, the first rectangular guide rail 405 and second rectangular guide rail 415 that are perpendicular to each other respectively contact the slider 407 with a tiny pressure. In one embodiment, the slider 407 is vertically adjusted to a height, such that the slider 407 is simultaneously surrounded by the first rectangular guide rail 405 and the second rectangular guide rail 415 and contacts them with a tiny pressure. In one embodiment, the groove 409 of the slider 407 is kept away from contacting the first rectangular guide rail 405 and the second rectangular guide rail 415.

Finally, in step S706, when the structure deforms, the horizontal displacement of the vertical reference cable 406 is calculated based on the strains of the first fiber Bragg grating 403 and the second fiber Bragg grating 413.

The fiber Bragg gratings are used as sensing units in the device and method for determining a horizontal displacement of a vertical reference cable of the present invention. Because of a simple mechanical structure and the advantages of fiber Bragg gratings, such as data stability, durability and no affection by humid environments, the device and method for determining a horizontal displacement of a vertical reference cable of the present invention can be very suitable for long-term use in harsh conditions.

Although the present invention has been described with reference to certain exemplary embodiments thereof, it can be understood by those skilled in the art that a variety of modifications and variations may be made to the present invention without departing from the spirit or scope of the present invention defined in the appended claims, and their equivalents.

What is claimed is:

1. A device for determining a horizontal displacement of a vertical reference cable, the device being installed in a structure with a vertical cavity and comprising:
a first rectangular guide rail and a second rectangular guide rail, wherein a short side of the first rectangular guide rail is coupled to an inner wall of the vertical cavity via a first leaf spring and a first fiber Bragg grating, a short side of the second rectangular guide rail is coupled to the inner wall of the vertical cavity via a second leaf spring and a second fiber Bragg grating, and the first rectangular guide rail and the second rectangular guide rail intersect perpendicularly to form a perpendicular cross space; and
a slider positioned in the perpendicular cross space and in contact with the first rectangular guide rail and the second rectangular guide rail, wherein the slider has a central through-hole allowing the vertical reference cable to pass through and the horizontal displacement of the vertical reference cable is calculated based on strains of the first fiber Bragg grating and the second fiber Bragg grating when the structure deforms.

2. The device as claimed in claim 1, wherein a first end of the first leaf spring and a first end of the first fiber Bragg grating are coupled to the inner wall of the vertical cavity via a first mounting base fixed to the inner wall of the vertical cavity, and a first end of the second leaf spring and a first end of the second fiber Bragg grating are coupled to the inner wall of the vertical cavity via a second mounting base fixed to the inner wall of the vertical cavity.

3. The device as claimed in claim 2, wherein the short side of the first rectangular guide rail is coupled to a second end of the first leaf spring and a second end of the first fiber Bragg grating via a first rectangular guide rail fixing unit, and the short side of the second rectangular guide rail is coupled to a second end of the second leaf spring and a second end of the second fiber Bragg grating via a second rectangular guide rail fixing unit.

4. The device as claimed in claim 2, wherein the horizontal displacement of the vertical reference cable along an x-axis and a y-axis when the structure deforms is expressed as:
$$\begin{matrix}x = \frac{{L}_{0} tan {θ}_{y} ( 1 - tan {θ}_{x} )}{1 + tan {θ}_{x} tan {θ}_{y}} \\ y = \frac{{L}_{0} tan {θ}_{x} ( 1 + tan {θ}_{y} )}{1 + tan {θ}_{x} tan {θ}_{y}}\end{matrix}$$
wherein the first rectangular guide rail is set along the x-axis, the second rectangular guide rail is set along the negative y-axis, and the vertical reference cable corresponds to the origin (0,0) when the structure is undeformed, a distance from the vertical reference cable to the first mounting base and a distance from the vertical reference cable to the second mounting base are both L0, and a strain of the first fiber Bragg grating and a strain of the second fiber Bragg grating correspond respectively to a deflection angle of θx of the first rectangular guide rail and a deflection angle of θy of the second rectangular guide rail.

5. The device as claimed in claim 1, wherein a first end of the vertical reference cable is fixed to a top portion of the structure, and a second end of the vertical reference cable is attached to a weight.

6. The device as claimed in claim 1, wherein a first end of the vertical reference cable is fixed to a bottom portion of the structure, and a second end of the vertical reference cable is attached to a tension providing device.

7. The device as claimed in claim 1, wherein the first leaf spring is aligned with a central axis of the first rectangular guide rail, and the second leaf spring is aligned with a central axis of the second rectangular guide rail.

8. The device as claimed in claim 1, wherein the slider has a groove recessed into the central through-hole, allowing the vertical reference cable to be squeezed into the central through-hole.

9. The device as claimed in claim 8, wherein a width of the groove and a diameter of the central through-hole of the slider are equal to a diameter of the vertical reference cable.

10. The device as claimed in claim 8, wherein the groove of the slider is kept away from contacting the first rectangular guide rail and the second rectangular guide rail.

11. A method for determining a horizontal displacement of a vertical reference cable in a structure with a vertical cavity, the method comprising:
providing a first rectangular guide rail and a second rectangular guide rail, wherein a short side of the first rectangular guide rail is coupled to an inner wall of the vertical cavity via a first leaf spring and a first fiber Bragg grating, a short side of the second rectangular guide rail is coupled to the inner wall of the vertical cavity via a second leaf spring and a second fiber Bragg grating, and the first rectangular guide rail and the second rectangular guide rail intersect perpendicularly to form a perpendicular cross space;
positioning a slider in the perpendicular cross space to contact the first rectangular guide rail and the second rectangular guide rail, wherein the slider has a central through-hole allowing the vertical reference cable to pass through; and
calculating the horizontal displacement of the vertical reference cable based on strains of the first fiber Bragg grating and the second fiber Bragg grating when the structure deforms.

12. The method as claimed in claim 11, wherein a first end of the first leaf spring and a first end of the first fiber Bragg grating are coupled to the inner wall of the vertical cavity via a first mounting base fixed to the inner wall of the vertical cavity, and a first end of the second leaf spring and a first end of the second fiber Bragg grating are coupled to the inner wall of the vertical cavity via a second mounting base fixed to the inner wall of the vertical cavity.

13. The method as claimed in claim 12, wherein the short side of the first rectangular guide rail is coupled to a second end of the first leaf spring and a second end of the first fiber Bragg grating via a first rectangular guide rail fixing unit, and the short side of the second rectangular guide rail is coupled to a second end of the second leaf spring and a second end of the second fiber Bragg grating via a second rectangular guide rail fixing unit.

14. The method as claimed in claim 12, wherein the horizontal displacement of the vertical reference cable along an x-axis and a y-axis when the structure deforms is expressed as:
$$\begin{matrix}x = \frac{{L}_{0} tan {θ}_{y} ( 1 - tan {θ}_{x} )}{1 + tan {θ}_{x} tan {θ}_{y}} \\ y = \frac{{L}_{0} tan {θ}_{x} ( 1 + tan {θ}_{y} )}{1 + tan {θ}_{x} tan {θ}_{y}}\end{matrix}$$
wherein the first rectangular guide rail is set along the x-axis, the second rectangular guide rail is set along the negative y-axis, and the vertical reference cable corresponds to the origin (0,0) when the structure is undeformed, a distance from the vertical reference cable to the first mounting base and a distance from the vertical reference cable to the second mounting base are both L₀, and a strain of the first fiber Bragg grating and a strain of the second fiber Bragg grating correspond respectively to a deflection angle of θₓ of the first rectangular guide rail and a deflection angle of θ_{y} of the second rectangular guide rail.

15. The method as claimed in claim 11, wherein a first end of the vertical reference cable is fixed to a top portion of the structure, and a second end of the vertical reference cable is attached to a weight.

16. The method as claimed in claim 11, wherein a first end of the vertical reference cable is fixed to a bottom portion of the structure, and a second end of the vertical reference cable is attached to a tension providing device.

17. The method as claimed in claim 11, wherein the first leaf spring is aligned with a central axis of the first rectangular guide rail, and the second leaf spring is aligned with a central axis of the second rectangular guide rail.

18. The method as claimed in claim 11, wherein the slider has a groove recessed into the central through-hole, allowing the vertical reference cable to be squeezed into the central through-hole.

19. The method as claimed in claim 18, wherein a width of the groove and a diameter of the central through-hole of the slider are equal to a diameter of the vertical reference cable.

20. The method as claimed in claim 18, wherein the groove of the slider is kept away from contacting the first rectangular guide rail and the second rectangular guide rail.
